(19) United States
(12) Patent Application Publication
(10) Pub. No.: US 2009/0068486 A1
(43) Pub. Date: Mar. 12, 2009

(54) HEAT SHRINK FILMS AND ARTICLES ENCAPSULATED THEREIN

(76) Inventors: Christopher J. Blackwell, Solon, OH (US); Kevin O. Henderson, Willoughby Hills, OH (US); Payal Kaul, Beachwood, OH (US)

Correspondence Address: RENNER, OTTO, BOISSELLE & SKLAR, LLP (AVERY), 1621 EUCLID AVE, 19TH FL, CLEVELAND, OH, 44115-2191, US

(21) Appl. No.: 11/719,542

(22) PCT Filed: Dec. 22, 2005
(86) PCT No.: PCT/US05/46964

§ 371 Date: May 17, 2007

Related U.S. Application Data
(60) Provisional application No. 60/638,490, filed on Dec. 23, 2004.

(51) Int. Cl. B32B 27/32

(52) U.S. Cl. 428/516; 428/523

(57) ABSTRACT

The present invention relates to a heat shrink film for encapsulating articles comprising a core layer having an upper surface and a lower surface, a first skin layer on the upper surface of the core layer, and a second skin layer underlying the lower surface of the core layer, wherein the core layer comprises a blend of (i) at least one polyterpene and (ii) a syndiotactic polypropylene or a cyclic olefin copolymer, wherein the ultimate shrinkage of the film is at least 25% at 135° C.

This application claims the benefit of U.S. Provisional Application No. 60/638,490, filed Dec. 23, 2004.

### TECHNICAL FIELD OF THE INVENTION

The invention relates to a heat shrink film having high shrink and low shrink tension in conjunction with high cross direction (CD) tensile modulus and high CD bending resistance or stiffness. More specifically, the invention relates to heat shrink films which are useful in encapsulating articles, such as batteries, liquid and powdered food and beverage containers, and irregular shaped containers that require heat shrinkable packaging and/or labeling, such as toys and containers.

### BACKGROUND OF THE INVENTION

Shrink films have been used for years to encapsulate articles. The shrink films must be able to shrink sufficiently to provide a smooth consistent coating. Previously, shrink films have been polyolefins and polyolefin blends which were and are used extensively in the food and packaging business to protect and preserve articles. Shrink films are also used to label containers. Initially, labeling operations were carried out using processes and methods that required the formation of a tube or sleeve of the heat shrink film which was then placed over the container and heated in order to shrink the film to conform to the size and shape of the container.

More recent packaging processes do not require a preformed sleeve and permit the application of the film directly from a continuous roll of film material onto the container. High-speed continuous operations generally employ biaxially oriented polypropylene shrink films. Such polypropylene shrink films have the ability to shrink up to about 25% as tested per ASTM Method D 2732 and ASTM Method D 1204. However, it is often desirable to obtain shrinkage of anywhere from 15 to 75%.

Polyvinyl chloride (PVC) films provide acceptable shrinkages of about 40%. However, such PVC shrink films do not have sufficient heat stability. After formation of the shrink film, the film should not shrink prematurely. Often the film is exposed to relatively high temperatures after formation, such as in transport. It is desired that the shrink film not shrink until application with heat to the bottle or article. Another disadvantage of PVC shrink films is the potential environmental impact of PVC film. Concern over the adverse affect of halogens on the ozone layer has lead to efforts to provide halogen free shrink films.

As an additional consideration, high-speed continuous operations require the use of an adhesive that will form an adequate bond between the container and the label. More specifically, the bond must be such that it will not separate at the seam during the heat-shrinking step. The bond should also form a smooth package, which will not bubble or cause creasing of the film during application. As the level of shrinkage desired is increased, the adhesive used in the high-speed applications must be able to provide an adequate bond while maintaining an acceptable appearance, e.g., without distortion. The adhesive must be compatible with the particular shrink film material used.

One problem with polyolefin and polyolefin film blends is the difficulty of printing on the film. For printing to be successful, the films must provide a surface which will accept printing. Additionally, the films must have sufficient tensile modulus to withstand the rigors of the printing process. Many polyolefin films do not have the tensile strength to withstand gravure printing. While orienting of the film uniaxially or biaxially can increase tensile strength and stiffness of the film sufficiently to withstand the printing process, conformability of the film to an article during the shrink process is decreased.

Appearance and structural defects are also encountered with shrink films. When shrink films are used for encapsulating cylindrical articles such as batteries or liquid beverage containers, the film must shrink sufficiently to encase the article. A common problem with encapsulating such articles is end puckering. End puckering occurs when the shrink film does not shrink sufficiently to provide a smooth encapsulating film at the ends of the battery. The film folds over itself and forms a “pucker”. This puckering is unacceptable to consumers and the manufacturer. Further, the shrink film can have fish eye defects which are small circular bubbles or ridges that can form on the film due to an apparently localized homogenous shrinking of the film.

In addition to “pucker” and “fish eye”, high shrink force or shrink tension in shrink films can lead to film shearing of the adhesive such that adhesive seams are not flush. This occurs in the case of low shear strength adhesives at the shrink temperature in question or when small cross sectional areas of adhesive are applied relative to the shrink label itself. A partial or complete adhesive failure can occur if the resulting force of the shrink film is in excess of the shear strength of the adhesive. In extreme circumstances, severe pulling and picking of the seams leads to ripping of the seam apart and failure of the shrink film to shrink over the desired package. Previously, shrink tension has been controlled by the use of large amounts of 1-polybutene. Shrink tension is measured by ASTM Method D2838. This use, however, while controlling shrink tension, adds cost to the product. It also adversely effects haze and modulus of the film when combined with certain polyolefins. This leads to the haze of the film being higher than desirable, and modulus being too low to process.

Therefore, it is desirable to have a film, which provides high shrinkages, e.g., shrinkages of at least 25%, while imparting a high CD modulus, ultimate CD tensile and bending stiffness. It is also desired to minimize the shrink force or shrink tension of the film in applications sensitive to high shrink tension. The desired film would smoothly encapsulate articles and avoid end puckering and shearing of adhesive seams.

### SUMMARY OF THE INVENTION

In one aspect, the invention relates to a multilayered heat shrink film for encapsulating articles comprising a core layer having an upper surface and a lower surface, a first skin layer on the upper surface of the core layer, and a second skin layer underlying the lower surface of the core layer, wherein the core layer comprises a blend of (i) at least one polyterpene and (ii) a syndiotactic polypropylene or a cyclic olefin copolymer, wherein the ultimate shrinkage of the film is at least 25% at 135° C.

In another aspect, the invention relates to a heat shrink film for encapsulating articles comprising a blend of (i) a homopolymer of polypropylene, (ii) at least one polyterpene; and (iii) a syndiotactic polypropylene or a cyclic olefin copolymer wherein the ultimate shrinkage of the film is at least 25% at 135° C.

In yet another aspect, the invention relates a multilayered heat shrink film for encapsulating articles comprising a core layer having an upper surface and a lower surface, a first skin layer overlying the upper surface of the core layer, a second skin layer underlying the lower surface of the core layer, wherein the core layer comprises a blend of a (i) a homopolymer of polypropylene and (ii) at least one polyterpene and (iii) a syndiotactic polypropylene or a cyclic olefin copolymer, wherein the ultimate shrinkage of the film is at least 25% at 135° C.

### BRIEF DESCRIPTION OF THE DRAWINGS

FIG. 1 is a schematic illustration of the side view of a multilayered film embodying the present invention in a particular form.

FIG. 2 is a schematic illustration of the side view of an embodiment of the multilayered film of the present invention including a tie layer.

FIG. 3 is a schematic illustration of the side view of an embodiment of the multilayered film of the present invention including sub skin layers.

FIG. 4 is a diagram of an apparatus for single-stage stretching for a uniaxially oriented film of the present invention.

FIG. 5 is a diagram of an apparatus for two-stage stretching for a uniaxially oriented film of the present invention.

FIG. 6 is a plot of the percent shrinkage (dimension change) versus change in temperature from 20 to 160° Celsius for the film of the present invention and commercially available films.

FIG. 7 is a plot of the maximum shrink force (N) versus change in temperature, from 20 to 1600 Celsius for the film of the present invention and commercially available films.

### DETAILED DESCRIPTION OF THE INVENTION

The present invention relates to heat shrink films and labels produced therefrom. The films and labels have a shrinkage of from about 15% up to about 75% with a low shrink tension desirable for the specific application use. The shrinkage is determined by ASTM Method D1204. The films, in one aspect, may be oriented in the machine direction, e.g., uniaxially oriented. In another aspect, the film may be biaxially oriented. The film may be a monolayer film or a multilayer film comprising two or more layers. The film typically has a thickness from about 0.5 mils to about 12.0 mils. Here and elsewhere in the specification and claims, the range and ratio limits may be combined.

The term “overlies” and cognate terms such as “overlying” and the like, when referring to the relationship of one or a first layer relative to another or a second layer, refers to the fact that the first layer partially or completely overlies the second layer. The first layer overlying the second layer may or may not be in contact with the second layer. For example, one or more additional layers may be positioned between the first layer and the second layer.

As used herein, the term “ultimate shrinkage” means the maximum shrinkage the film is capable of achieving at a particular shrink temperature, as measured by ASTM Method D 1204. The term instantaneous shrinkage means the shrinkage obtained when the film is exposed to the shrink temperature for less than 1 second. The instantaneous shrinkage of a particular film is determined by extrapolating the shrinkage percentage obtained for the film using ASTM Method D 2732 for immersion times of 10, 20, 40, 60, 120 and 240 seconds at a specified shrinkage temperature.

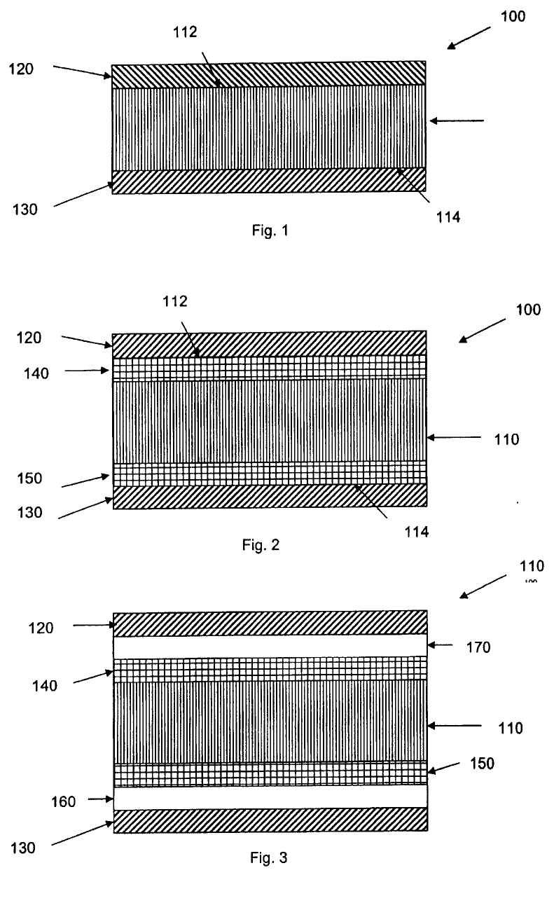

The films and labels of the present invention are illustrated in reference to the attached drawings. FIG. 1 is a schematic illustration of a side view of a film of the present invention. Film 100 is a coextrudate that comprises core layer 110 which has a first surface 112 and a second surface 114, first skin layer 120 on the upper surface of the core layer and second skin layer 130 on the lower surface of the core layer.

The overall thickness of the film 100 may be in the range of about 0.5 to about 12.0 mils, and in one embodiment of about 1 mils to about 8 mils, and in one embodiment of about 1.5 mils to about 4 mils. The thickness of the core layer may range from about 30% to about 90% of the overall thickness of the multilayered film 100, and in one embodiment about 40% to about 85%, and in one embodiment about 50% to about 80% of the overall thickness of the film 100. The first 120 and second 130 skin layers may have a thickness of about 5 to about 35% of the overall thickness of the film 100, and in one embodiment about 10 to about 30%, and in one embodiment about 15% to about 25% of the overall thickness of the film 100. The first 120 and second 130 skin layers can be the same thickness or of a different thickness.

The shrink tension of the film 100, as measured by ASTM D2838 at 135° C., in one embodiment is less than 3135 kPa (kilopascals), and in one embodiment less than 2653 kPa, and in one embodiment less than 2274 kPa, and in one embodiment less than 2067 kPa.

### Core Layer

The core layer comprises a major portion of the multilayer shrink film. Typically, the core layer has a thickness from about 0.6 to about 4, or from about 0.8 to about 3, or from about 1 to about 2.5, or from about 1.2 to about 2 mils thick. The films have sufficient strength to be printed by flexographic and gravure printing. These films generally have a Young's modulus from about 60,000 to about 500,000, or from about 100,000 to about 400,000, or from about 150,000 to about 300,000 psi. Young's modulus is determined by ASTM D882-61T

As described above, the multilayered shrink films have, in one embodiment, a core layer, which may be comprised of a polypropylene resin and a polyterpene additive in a carrier resin. The polypropylene generally comprises a polypropylene homopolymer, a nucleated polypropylene homopolymer, a polypropylene copolymer, a nucleated polypropylene copolymer, or mixtures thereof. In one embodiment, the polypropylene resin comprises a nucleated polypropylene homopolymer. An example of a commercially available nucleated polypropylene homopolymer that may be used is P4GK-173X from Huntsman. This material is identified as having a melt flow rate of 12 g/10 min. (ASTM D1238), a density of 0.9 g/cm³ (ASTM D1505) and a flexural modulus of 1310 MPa (ASTM D790). Other examples of commercially available nucleated homopolymers are BP Amaco homopolymer HF12G1 and Dow H700-12NA.

The polyterpene resin generally comprises a blend or concentrate of a polyterpene in a carrier resin, such as a polypropylene homopolymer or copolymer. The polyterpene resin blended with the polypropylene resin provides improved stiffening action, increased modulus and increased strength of the resulting film, as well as acting as a densifying component that can lower the shrink force of the film. The polyterpene resins are a well-known class of resinous materials obtained by the polymerization or copolymerization of one or more terpene hydrocarbons such as the alicylic, mono-cyclic and bicyclic terpenes, and their mixtures, including careen, isomerised pinene, dipentene, terpinene, terpinolene, turpentine, a terpene cut or fraction, and various other terpenes.

In one embodiment, the polyterpene comprises a hydrogenated polyterpene, which is also effective for improving the properties of the films. These are produced by hydrogenating the polyterpenes by any of the usual hydrogenation processes. Generally, the hydrogenation is carried out utilizing a catalyst such as nickel, nickel on kieselguhr, copper chromite, palladium on alumina, or cobalt plus zirconia or kieselguhr. Hydrogenation can be accomplished in an inert solvent such as methyl cyclohexane, toluene, p-methane, etc., utilizing pressures ranging from 500 to 10,000 psi and a temperature of 1500 to 300° C. Useful hydrogenated polyterpenes include those having a melt index of 8-15 g/10 min. at 190° C. An example of a commercially available hydrogenated polyterpene resin is Exxelor PA609A from Exxon Mobil. This resin is identified as having a melt index of 11 g/10 min. (ASTM D1238) and a density of 0.975 g/cm³ (ASTM D1505). Another example of a commercially available polyterpene resin is Exxelor PA609N from Exxon Mobil. This resin is identified as having a melt index of 11 g/10 min and a density of 0.975 g/cm³.

The blend of polypropylene resin and polyterpene resin is comprised of about 10% to about 60% by weight of polypropylene resin and about 40% to about 90% polyterpene resin. In one embodiment, the blend comprises from about 20% to about 40% polypropylene resin and about 15% to about 40% polyterpene resin.

In addition to the polypropylene resin and the polyterpene resin, the core layer, in one embodiment, will contain syndiotactic polypropylene blended with the propylene and polyterpene resins. Syndiotactic polypropylene is a polypropylene having a high syndiotacticity, such that the syndiotactic index or [r] value obtained from NMR data is at least 0.7. Such syndiotactic polypropylene is described in U.S. Pat. Nos. 5,476,914 and 6,184,326, incorporated herein by reference. Commercially available syndiotactic polypropylene useful in the present invention includes those available from Atofina under the trade designations Finaplas 1471, Finaplas 1571 and Finaplas 1251. In one embodiment, the core layer contains syndiotactic polypropylene in an amount from about 20% to about 70% by weight, in another embodiment, about 30% to about 60% by weight, and in another embodiment about 35% to about 55% based on total weight of the core layer.

In one embodiment, the core layer will contain one or more additional thermoplastic polymers. The thermoplastic polymer can comprise a polyolefin, an alkene-vinyl carboxylate ester copolymer, an alkene-alkyl (meth)acrylate copolymer, an ethylene-butyl acrylate or methacrylate copolymer, a grafted or functionalized polyolefin, an impact polymer, an ionomer, or combinations thereof.

In one embodiment, the core layer will contain a copolymer of propylene with an alpha olefin. The copolymers of propylene generally have a melt flow of about 0.5 to about 12 g/10 min, or from about 4 to about 12 g/10 min. The polyolefins which can be utilized in the core layer 110 include polymers and copolymers of olefin monomers containing from about 2 to about 12 carbon atoms, or from about 2 to about 8 carbon atoms, such as ethylene, propylene, 1-butene, 1-pentene, 1-hexene, 1-heptene, 1-octene, etc. Preferred alpha olefins are ethylene and 1-butene or blends of mixtures of such polymers and copolymers. In one embodiment the polyolefins comprise polymers and copolymers of ethylene and propylene. In another embodiment, the polyolefins comprise copolymers such as propylene-ethylene and propylene-1-butene copolymers. Blends of polypropylene and polyethylene with each other, or blends of either or both of them with polypropylene-polyethylene copolymer also are useful.

In addition to the nucleated polypropylene homopolymer resin and polyterpene resin, the core layer may also contain other film forming polymeric resins in a lesser amount, generally about 5 to about 45% by weight based on the total weight of the core layer. In one embodiment, the core layer contains about 20 to about 40% by weight, and in another embodiment, about 20% to about 35% by weight of a polymeric resin based on the total weight of the core layer. Such polymeric resins include copolymers of ethylene with another alpha olefin, functionalized polyethylene, low density polyethylene, a copolymer of ethylene and propylene, cyclic olefin copolymer, or a mixture of two or more thereof. The copolymers of ethylene with another alpha olefin include ethyl vinyl acetate copolymers (EVA), ethylene butyl acrylate copolymer (EBA), ethylene methyl acrylate (EMA), functionalized or grafted polyethylenes, and polyethylenes with a hexene or octene branch, such as Dow Affinity KC 8852. A useful EVA copolymer is AT Plastics 1821A. An example of a useful EMA is TC-120 from Exxon Mobil, and an EBA being Eastman Kodak's SP 1802. Useful functionalized or grafted polyethylenes include DuPont Bynel 3048, an anhydride modified ethylene vinyl acetate, DuPont Bynel 3101, an acid/acrylate modified ethylene vinyl acetate, DuPont Bynel 4006, an anhydride modified high density polyethylene, and DuPont Bynel 41E556, an anhydride modified linear low density polyethylene. The polyethylenes utilized will generally be high density polyethylene, linear low density and very low-density polyethylenes. A useful high density polyethylene is HD2015 from Huntsman. Examples of useful linear low density polyethylenes (LLDPE) are L8148 available from Huntsman, Dynex® D6053C, MarFlex® PE7109L and Vytek® V208C6, all available from Chevron Phillips. Commercially available very low-density polyethylenes (VLDPE) or metallocene polyethylenes include Dow Affinity KC 8852, Dow Attane 4402, Nova Sclair 10A, and Exxon Exact 4151. Useful ethylene-propylene copolymers include P5M4K-070X available from Huntsman, Acclear 8359 from BP Amaco, and Versify 3000, Versify 3200 and Versify 3300 available from Dow Chemical. Useful cyclic olefin copolymers include Ticona Topaz 8007 and Topaz 9506. Other cyclic olefins can be found from Zeon Chemicals LP as Zeonor 1020R and Zeonor 1060R.

In one embodiment, a homopolymer of butylene or a copolymer of butylenes with an alpha olefin is blended with the propylene copolymer described above. The copolymer of butylene with an alpha olefin may comprise a copolymer of butylene with ethylene, propylene, butylene, pentene, hexane, heptene, octane, nonene, decene, etc. Particularly useful are butylene-ethylene copolymers. The butylene-ethylene copolymer typically includes ethylene at a level of about 0.5% to about 12%. Examples of useful butylene-ethylene copolymers are those available from Basell under the trade designation DP 8220, which has an ethylene content of 2% and a melt flow of 2.0 g/10 min, and under the trade designation DP 8310, which has an ethylene content of 6% and a melt flow of 3.2 g/10 min. Examples of butylene homopolymers include those identified as 0300 (melt flow 4.0 g/10 min) available from Basell. The copolymer of butylenes may also comprise an ethylene-propylene-butylene terpolymer.

The core layer, in one embodiment, includes polyisobutylene (PIB), which has been found to lower the crystallinity of isotactic polypropylene and, in specific combinations with other olefins, lower the shrink tension, while reducing fish eye defects in the film. The polyisobutylene may be selected from one or more low molecular weight polyisobutylenes having a viscosity average molecular weight of from 36,000 to 70,000. Such polyisobutylenes are commercially available under the trademark Vistanex from Exxon Chemical as grades LMMS, LMMH and LMH, having viscosity average molecular weights of about 45,000, 53,000 and 63,000 respectively. The low molecular weight polyisobutylene may be present in an amount corresponding to from about 0.2% to about 5.5% by weight of the core layer. High molecular weight polyisobutylene may be used in the viscosity average molecular weight range of 800,000 to 2,500,000 and is exemplified by the Vistanex MM series of products, available from Exxon Chemical. The polyisobutylene generally comprises, in one embodiment, from about 0.2% to about 5.5%, and in one embodiment from about 0.5% to about 4%, and in one embodiment from about 1% to about 3%.

Table 1 contains examples of formulations for the core layer of the present films. Here and throughout the specification and claims the amounts are by weight, unless clearly indicated otherwise.

### EXAMPLES

TABLE 1

| | | | | | | PEH | | |
|---|---|---|---|---|---|---|---|---|
| Core | | | | | | or | | |
| Identity | SPP¹ | NPPH² | PIB³ | PT⁴ | PPC⁵ | PEC⁶ | PB⁷ | COC⁸ |
| C1 | 40 | 20 | 0.5 | 39.5 | — | — | — | — |
| C2 | 50 | 30 | 3 | 17 | — | — | — | — |
| C3 | 46.5 | 29 | 2.5 | 22 | — | — | — | — |
| C4 | 40 | 40 | — | 20 | — | — | — | — |
| C5 | 60 | 5 | 1 | 20 | 5 | 9 | — | — |
| C6 | 40 | 20 | 1 | 9 | 10 | 5 | 15 | — |
| C7 | 40 | — | 1 | 30 | — | 29 | — | — |
| C7A | 40 | — | 1 | 30 | 29 | — | — | — |
| C8 | 40 | — | 1 | 29 | 30 | — | — | — |
| C9 | 30 | 10 | — | 20 | 20 | 20 | — | — |
| C10 | 35 | — | — | 50 | — | 15 | — | — |
| C11 | 70 | — | — | 20 | — | 10 | — | — |
| C12 | — | 20 | — | 20 | — | 20 | — | 40 |
| C13 | — | 20 | — | 20 | — | 40 | — | 20 |

¹SPP is syndiotactic polypropylene.
²NPPH is nucleated polypropylene homopolymer.
³PIB is polyisobutylene.
⁴PT is polyterpene.
⁵PPC is polypropylene copolymer.
⁶PEH or PEC is polyethylene homopolymer or polyethylene copolymer.
⁷PB is poly(1-butene).
⁸COC is cyclic olefin copolymer.

### Skin Layer

The multilayer shrink film can comprise one or more skin layers. The skin layers can be printable skin layers. In one embodiment, the film 100 has a first skin layer 120 on the upper surface 112 of the core layer 110 and second skin layer 130 on the lower surface 114 of the core layer 110. In one embodiment, skin layers 120, 130 comprise the same composition. In another embodiment, skin layers 120, 130 are different in composition. In one embodiment, skin layers 1230, 130 comprise a thermoplastic polymer or copolymer derived from propylene or ethylene. The homopolymers and copolymers of propylene and ethylene are described above.

In one embodiment, skin layers include one or more of the above-described alpha olefins such as polyethylene, polybutylene, an ethylene-butylene copolymer, or an ethylene-propylene-butylene terpolymer; an ethylene-methyl acrylate copolymer; an ethylene-vinyl acetate copolymer; an ethylene-ethyl acrylate copolymer; a poly(methyl methacrylate), an acrylonitrile-butadiene-styrene copolymer; a nylon; a polybutene; a polyisobutylene; a polystyrene; a polyurethane; a polysulfone; a poly(vinylidene chloride); a polycarbonate; a poly(4-methyl-1-pentene), a styerne-maleic anhydride copolymer; a styrene-acrylonitrile copolymer; a cellulosic, a fluoroplastic, a polyacrylonitrile; a thermoplastic polyester, or mixtures thereof. The polyolefin blend is typically present in an amount from about 20% up to about 100% in one embodiment, and from about 40% to about 99% in one embodiment, and from about 30% up to about 70% by weight in one embodiment.

In another embodiment, the multilayer film of the present invention comprises at least one skin layer comprising a thermoplastic material of a copolymer of an ethylene-unsaturated carboxylic acid or anhydride, an ionomer derived from sodium, lithium or zinc and ethylene/unsaturated carboxylic acid or anhydride copolymers or combinations thereof. Useful ionomer resins include those available from DuPont under the tradename Surlyn. These resins are identified as being derived from sodium, lithium or zinc and copolymers of ethylene and methacrylic acid, including Surlyn 1605, 7940 and 9120. Ethylene-methacrylic acid copolymers that are useful include those available from DuPont under the tradename Nucrel, such as include Nucrel 0407, which has a methacrylic acid content of 4% by weight and a melting point of 109° C. Useful ethylene/acrylic acid copolymers include those available from Dow Chemical under the tradename Primacor, such as Primacor 1430, which has an acrylic acid monomer content of 9.5% by weight and a melting point of 97° C. The concentration of the foregoing thermoplastic polymers in the skin layer 120 is generally from about 20% to about 100%, based on the overall weight of the skin layer 120, and in one embodiment from about 30% to about 50%.

In one embodiment, at least one of the skin layers comprises a homopolymer of butylene. Examples of butylenes homopolymers include those identified above available from Basell. The butylenes generally comprises from about 5 to about 35% in one embodiment, and in one embodiment from about 15% to about 20% based on the total weight of the skin layer.

In another embodiment at least one of the skin layers will comprise a polyterpene as described above. In one embodiment the skin layer will comprise from about 10% to about 90% polyterpene, and from about 30% to about 70% polyterpene in another embodiment.

Table 2 illustrates examples of formulations for the skin layers:

TABLE 2

| | S1 | S2 | S3 | S4 | S5 | S6 | S7 | S8 | S9 | S10 |
|---|---|---|---|---|---|---|---|---|---|---|
| Nucleated | 60 | 0 | 20 | 50 | 0 | 0 | 0 | 90 | 50 | 60 |
| Homopolymer | | | | | | | | | | |
| PP | | | | | | | | | | |
| PP-alpha olefin | 0 | 60 | 30 | 0 | 80 | 100 | 0 | 0 | 50 | 0 |
| Copolymer | | | | | | | | | | |
| PE or PE-alpha | 40 | 40 | 50 | 50 | 0 | 0 | 100 | 0 | 0 | 40 |
| olefin copolymer | | | | | | | | | | |
| Ionomer | 0 | 0 | 0 | 0 | 20 | 0 | 0 | 10 | 0 | 0 |
| Polybutene-1 | 0 | 0 | 0 | 0 | 0 | 0 | 0 | 0 | 0 | 0 |
| | S11 | S12 | S13 | S14 | S15 | S16 | S17 | S18 | S19 | S20 |
| Nucleated | 0 | 20 | 60 | 40 | 70 | 80 | 0 | 100 | 35 | 100 |
| Homopolymer | | | | | | | | | | |
| PP | | | | | | | | | | |
| PP-alpha olefin | 60 | 30 | 40 | 60 | 20 | 10 | 80 | 0 | 35 | 0 |
| Copolymer | | | | | | | | | | |
| PE or PE-alpha | 40 | 50 | 0 | 0 | 10 | 0 | 0 | 0 | 20 | 0 |
| olefin copolymer | | | | | | | | | | |
| Ionomer | 0 | 0 | 0 | 0 | 0 | 0 | 0 | 0 | 5 | 0 |
| Polybutene-1 | 0 | 0 | 0 | 0 | 0 | 10 | 20 | 0 | 5 | 0 |
| | S21 | S22 | S23 | S24 | S25 | S26 | S27 | S28 | S29 | S30 |
| Nucleated | 95 | 0 | 0 | 20 | 0 | 20 | 70 | 30 | 0 | 25 |
| Homopolymer | | | | | | | | | | |
| PP | | | | | | | | | | |
| PP-alpha olefin | 0 | 70 | 50 | 30 | 0 | 20 | 0 | 50 | 40 | 25 |
| Copolymer | | | | | | | | | | |
| PE or PE-alpha | 5 | 30 | 0 | 10 | 40 | 20 | 30 | 0 | 0 | 10 |
| olefin copolymer | | | | | | | | | | |
| Ionomer | 0 | 0 | 0 | 0 | 0 | 10 | 0 | 0 | 0 | 0 |
| Polybutene-1 | 0 | 0 | 0 | 0 | 0 | 0 | 0 | 0 | 0 | 5 |
| Polyterpines | 0 | 0 | 50 | 40 | 60 | 30 | 0 | 20 | 60 | 25 |

In one embodiment, it is desired to subject the surface of at least one of the skin layers to a high-energy discharge (or plasma) such as the high-energy electrical discharges produced by corona discharge and glow discharge which are well-known in the industry. Corona discharge is a high-energy, high-ionizing discharge that is produced at electrodes when a high voltage is applied across the plates of a condenser (capacitor). The corona discharge treatment improves the surface energy of the upper surface of the skin layer and improves printability of the surface. Alternatively, the surface of at least one skin layer is subjected to variations of corona treatment such as covered roll, universal roll (also known as dual dielectric) and bare roll technologies. In another embodiment, flame treatment is used to treat the skin layer. The skin layers may be printed using conventional printing techniques. For example, gravure, flexographic and UV flexographic printing processes may be used to print the skin layer. Water based, solvent based and UV curable inks may be used to print the skin layer. In one embodiment, the film is reverse printed with a design, image or text so that the print side of the skin is in direct contact with the surface to which the film is applied.

As noted above, the core layer is relatively thick compared to the outer, e.g., skin layers. Thus, the core layer may be bout 2 to 20 times as thick as each of the outer layers. Examples of thickness ratios of the core to the outer layers combined include 90:10, 80:20, 70:30 etc. The thickness ratios of the skin layer to the core and then to the other skin layer are 1-20:60-90:1-20, or 5-15:70-90:5-15. Thickness ratios of three layered films include 5:90:5, 10:80:10, 15:70:15, 20:60:20, etc. The two skin layers do not have to be of equal thickness.

The skin layers 120 and 130 may contain an effective amount of a processing aid to facilitate extrusion. While not wishing to be bound by theory, it is believed that these processing aids have a high affinity to metal surfaces and thereby prevent or reduce the tendency of the polymer compositions being extruded from adhering to the inner walls of the extrusion equipment. This makes it easier to purge the extrusion equipment during color changeovers. These processing aids include hexafluorocarbon polymers. An example of a commercially available processing aid that can be used is Ampacet 401198 which is a product of Ampacet Corporation identified as a hexafluoro carbon polymer. The processing aids are typically used at concentrations of up to about 1.0% by weight, and in one embodiment about 0.2% to about 0.5% by weight.

The film 110 may contain pigments, fillers, stabilizers, optical brighteners, anti-oxidants, glow in the dark concentrates, nucleating agents, clarifying agents, process aids, oxygen scavengers, anti-fog agents, foaming agents, light protective agents or other suitable modifying agents if desired. Pigments or color concentrates may be used to add color, such as white, black, gray, blue, red, orange, yellow, or green. Examples of useful pigments are: Ampacet 101359-B (white Ti02 concentrate), Ampacet 150425 (red concentrate), Ampacet 13381-A (yellow concentrate), Ampacet 12083 (silver concentrate), Ampacet 17106 (green concentrate), Ampacet 14445 (orange concentrate), Ampacet 161201 (blue concentrate), and Ampacet 190405 (black concentrate). An example of a useful optical brighter is Ampacet 40247. An example of a useful UV light stabilizer is Ampacet 10561. A useful antioxidant is Polyfil 0524M. Useful nucleating agents include Miliken's Milad 3988 and Amfine's NA11 and NA21.

The film may also contain anti-block, slip additives and anti-static agents. Useful anti-block agents include inorganic particles, such as clays, talc, calcium carbonate and glass. An example of a useful antiblock is Ampacet 401960 (Seablock-4). A synthetic silica antiblock from A. Schulman that is useful is ABPP05-SC. Slip additives useful in the present invention include polysiloxanes, waxes, fatty amides, fatty acids, metal soaps and particulate such as silica, synthetic amorphous silica and polytetrafluoroethylene powder. A useful slip additive is SPER 6 from A. Schulman. Other slip additives from Ampacet include 10025, 100329, and 100358-XL. Anti-static agents useful in the present invention include alkali metal sulfonates, polyether-modified polydiorganosiloxanes, polyalkylphenylsiloxanes and tertiary amines. A useful antistatic agent is VLA55SF from A. Schulman. Other useful anti-static agents from Ampacet include 10053 and 101710.

In one embodiment, the film 100 has a low coefficient of friction (COF) surface, which can allow movement of the film while it is being shrink onto an article. Lack of movement can cause defects such as wrinkles, air pockets and fish eyes. In one embodiment, a low COF surface comprises a slip agent such as an erucamide or oleamide which is incorporated into the film or a skin layer. In one embodiment, a low COF surface comprises an inherently low COF polymer such as a high density polyolefin in the film or a skin layer.

In one embodiment, as shown in FIG. 2, the multilayer shrink film 100 of the present invention may comprise one or more tie layers 140, 150. Tie layer 140, 150 may be any polymer which improves adhesion of the layers. Examples of suitable tie layers include: polyethylene copolymers including those having a high alpha-olefin content, ethylene methacrylic acid copolymers, ethyl vinyl acetate copolymers, anhydride grafted ethyl vinyl acetate copolymers, anhydride grafted ethylene polymers, ionomers, styrene butadiene copolymers, and C₃ or higher polyolefin copolymers having a high alpha olefin comonomer contents such as a propylene-1-butene copolymer having a 1-butene content up to 14% by weight.

In another embodiment, the film 100 can include one or more subskin layers 160, 170 between the skin layers 120, 130 and tie layers 140, 150, as shown in FIG. 3. The subskin layers may be comprised of the same materials as the skin layer 120 and/or skin layer 130.

The heat shrink films may be prepared by means known to those in the art. The film may be prepared by co-extrusion through a cast-die or annular die, extrusion coating through a cast die or annular die, a coating, or a lamination. In one embodiment, the shrink film is a lamination of two separate multilayer films. In another embodiment, the film is a lamination of a multilayer film and a monolayer film, or combinations thereof. In one embodiment, the film is made through a cast process in which the film is made in roll form, followed by stretching in a machine direction orientation line. In one embodiment, the film is made via a blown film or bubble process followed by stretching as described above. In another embodiment, the film is made via a double bubble process and the two films laminated together.

The films can be of equal or different thicknesses and of the same or different compositions. In one embodiment, the lamination is an adhesive lamination using a pressure sensitive adhesive. In another embodiment, the lamination is a heat seal lamination.

The films may also be taken through secondary processes. This includes metallization through vacuum metallization; printable topcoats applied as needed to enhance the decorative nature of the label, lamination, or protective coatings such as lacquers.

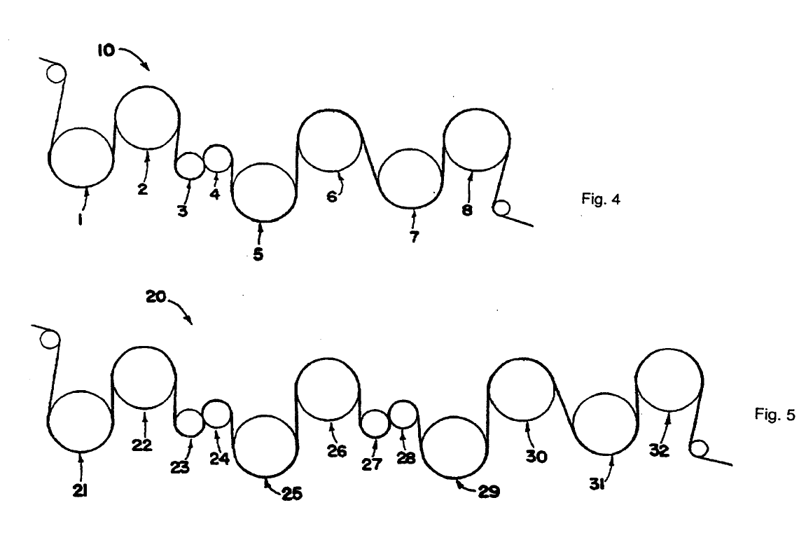

As discussed above, the films may be directionally oriented. In one embodiment, the films will be uniaxially oriented. Uniaxially oriented films are stretched in only one direction. Machine direction orientation is accomplished by stretching the film as is known in the art. In one embodiment, the extruded sheet is stretched in the machine direction only, in a single-stage stretching process. FIG. 4 illustrates an apparatus 10 useful for the single-stage stretching of the film of the present invention. The extruded film proceeds through preheat rolls 1 and 2, and then draw rolls 3 and 4 where it is stretched. The film then passes through annealing rolls 5 and 6, and then to cooling rolls 7 and 8. In one embodiment of the single stage stretching process, preheat rolls 1 and 2 are set at 220° F. (104° C.), draw rolls 3 and 4 are set at 230° F. (110° C.), annealing rolls 5 and 6 are set at 150° F. (66° C.), and cooling rolls 7 and 8 are set at 100° F. (38° C.) and 75° F. (24° C.). The draw ratio between rolls 3 and 4 is about 5.5:1. In generally, the multilayer films of the present invention typically have a stretch ratio from about 2 to about 9, or from about 3.5 to about 7, or from about 4 to about 6. In general, the temperature ranges of the preheat rolls are from about 180° F. (82° C.) to about 260° F. (127° C.), the draw rolls from about 180° F. (82° C.) to about 260° F. (127° C.), the annealing rolls from about 100° F. (38° C.) to about 260° F. (127° C.) to, and the cooling rolls from about 75° F. (24° C.) to about 130° F. (54° C.).

In another embodiment, the extruded sheet is uniaxially oriented using a two-stage stretching process wherein the extruded sheet is stretched twice in the machine direction. FIG. 5 illustrates an apparatus 20 useful for two-stage stretching of the film of the present invention. The extruded film proceeds through preheat rolls 21 and 22, and then draw rolls 23 and 24 where it is stretched. The film then passes through another set of preheat rolls 25 and 26, and then a second set of draw rolls 27 and 28 where it is again stretched. The film then passes through annealing rolls 29 and 30, and then to cooling rolls 31 and 32. In one embodiment of the two-stage stretching process, preheat rolls 21 and 22 are set at 230° F. (110° C.), draw rolls 23 and 24 are set at 245° F. (118° C.), preheat roll 25 is set at 260° F. (127° C.), preheat roll 26 and draw rolls 27 and 28 are set at 200° F. (93° C.), annealing rolls 29 and 30 are set at 150° F. (66° C.) and cooling rolls 31 and 32 are set at 100° F. (38° C.) and 75° F. (24° C.), respectively. The draw ratio between draw rolls 23 and 24 is about 4.5 to 1, and between draw rolls 27 and 28 is about 1.2-1.5:1.

As described above, the films are useful in many shrink film applications for encapsulating articles including batteries, aluminum soda can containers, aerosol cans, plastic liquid beverage containers, plastic milk containers, powdered containers such as powdered coffee creamer or powdered lemonade, glass containers holding food and beverage product, and irregular shaped containers that require heat shrinkable packaging such as toys, health and beauty aids, pharmaceutical/nutritional applications such as: vitamins, powered nutritional supplements, baby formula, cosmetics such as foundation and lipstick, lip balm, and hand soaps and sanitizers in plastic containers. In one embodiment of a labeling process, a roll of the film is fed into a label applicator where a transport feed roller directs the film to a cutting station. At the cutting station, a cutting drum shear cuts the film into segments. The film segment, or label, is directed to the adhesive station where an adhesive strip is applied to both the leading edge and trailing edge of the label. A vacuum assisted drum then transfers the label to the article to be labeled. A UV lamp cures the adhesive on the leading and trailing edges of the label. The article with the affixed label is then sent through a heat shrink tunnel where the label shrinks to conform to the article. These tunnels can be hot air, steam or IR heated. The label application process is a high-speed process.

Useful adhesives for such applications include adhesives that are capable of shrinking with the shrink film, at least 40%, and in one embodiment up to 80%, without adversely affecting the appearance of the film or becoming detached from the article. Such adhesives include hot melt adhesives and radiation curable adhesives. A particularly useful radiation curable adhesive comprises:

(a) a base resin, such as an epoxidized block copolymer (as described in U.S. Pat. No. 5,516,824 and U.S. Pat. No. 5,776,998); and/or a cycloaliphatic epoxy (such as CYRACURE UVI6110 available from Dow Chemical); an olefin including that having a C—C double bond pendant to the backbone or on ends—such materials may be oligomeric, polymeric or monomeric and the backbone may vary in polarity ranging from aliphatic, urethane, polyester and polyether);

(b) a photoinitiator, the type of which is dependent on the type of chemistry of the base resin, e.g., cationic photoinitiator suitable for curing epoxidized block copolymer, cycloaliphatic epoxies, and vinyl ether olefins which includes sulfonium or iodonium salts such as SARCAT CD1010, SARCAT CD1011 and SARCAT CD1012 (available from Sartomer) and CYRACURE UVI 6974 available from Dow Chemical. For free-radical curing systems such as olefinic or thiol-ene curing systems the following photoinitiators may be suitable: IRGACURE 651, 184 and 1700 and DAROCURE 1173, available from CIBA-GEIGY; as well as GENOCURE LBP available from Rahn; and ESACURE KIP150 available from Sartomer. Other examples of photoinitiators which may be used include one or more of the following: benzophenone, benzyldimethyl ketal, isopropyl-thioxanthone, bis(2,6-dimethoxybenzoyl)(2,4,4-trimethylpentyl) phosphineoxide, 2-hydroxy-2-methyl-1-phenyl-1-propanone, diphenyl(2,4,6-trimethybenzoyl) phosphine oxides, 1-hydroxycyclohexyl phenyl ketone, 2-benzyl-2-(dimethyl-amino)-1-4-(4-morpholinyl)phenyl-1-butanone, alpha,alpha-dimethoxy-alpha-phenylacetophenone, 2,2-diethoxyacetophenone, 2-methyl-1-4-(methylthio)phenyl-2-(4-morpholinyl)-1-propanone, 2-hydroxy-1-4-(hydroxyethoxy)phenyl-2-methyl-1-propanone.

(c) a tackifier, such as the C₅-C₉ hydrocarbon resins, synthetic polyterpenes, rosin, rosin esters, natural terpenes, and the like. More particularly, the useful tackifying resins include any compatible resins or mixtures thereof such as natural and modified rosins including gum rosin, wood rosin, tall oil rosin, distilled rosin, hydrogenated rosin, dimerized rosin, and polymerized rosin; glycerol and pentaerythritol esters of natural and modified rosins, including the glycerol ester of pale, wood rosin, the glycerol ester of hydrogenated rosin, the glycerol ester of polymerized rosin, the pentaerythritol ester of hydrogenated rosin, and the phenolic-modified petaerythritol ester of rosin; copolymers and terpolymers of natural terpenes, such as styrene/terpene and alpha methyl styrene/terpene; polyterpene rosins generally resulting from the polymerization of terpene hydrocarbons, such as the bicyclic monoterpene known as pinene, in the presence of Friedal-Crafts catalysts at moderately low temperatures; also included are the hydrogenated polyterpenes resins; phenolic modified terpene resins and hydrogenated derivatives thereof such as, for example, the resin product resulting from the condensation, in an acidic medium, of a bicyclic terpene and a phenol; aliphatic petroleum hydrocarbon resins resulting from the polymerization of monomers consisting primarily of olefins and diolefins; hydrogenated aliphatic petroleum hydrocarbon resins; and cyclic or acyclic C₅ resins and aromatic modified acyclic or cyclic resins. Mixtures of two or more of the above-described tackifying resins may be required. An example of a commercially available solid hydrogenated tackifer is ESCOREZ 5400 from Exxon. Examples of useful liquid tackifying resins include REGALITE R-10 a C₅ liquid tackifier with a softening point of 10° C. available from Hercules, and WINGTACK 10, a liquid hydrocarbon resin with a softening point of 10° C. available from Goodyear Chemical Co.;

(d) a diluent, such as a plasticizing or extending oil including olefin oligomers and low molecular weight polymers as well as vegetable and animal oil and their derivatives. The petroleum derived oils which may be employed are relatively high boiling materials containing only a minor proportion of aromatic hydrocarbons (preferably less than 30% and, more particularly, less than 15% by weight of the oil). Alternatively, the oil may be totally non-aromatic. Suitable oligomers include polypropylenes, polybutenes, hydrogenated polyisoprene, hydrogenated polybutadiene, or the like having average molecular weights between about 350 and about 10,000. Examples of useful mineral oils include refined hydrocarbon oils such paraffinic, aromatic and naphthalenic oils available under the trade designations KAYDOL from Witco, TUFFLO from Arco, and the like;

(e) a wax, such as a petroleum derived paraffinic or mycrocrystalline wax (including PACEMAKER 53 available from Citgo) is useful for altering the viscosity, green strength, and reducing tack of the final composition;

(f) a compatible polymer such as a block copolymer including polystyrene-polybutadiene-polystyrene, polystyrene-polyisoprene-polystyrene, poly(alpha-methyl-styrene)-polybutadiene-poly(alpha-methyl-styrene), poly(alpha-methyl-styrene)-polyisoprene-poly(alpha-methylstyrene), as well as the hydrogenated modifications thereof, e.g., polystyrene-poly(ethylene-butylene)-polystyrene. These copolymers may be prepared by methods taught, for example, in U.S. Pat. Nos. 3,239,478; 3,247,269; 3,700,633; 3,753,936 and 3,932,327. For higher polarity systems, polymers such as polyesters (e.g. DYNAPOL materials available from Huls and sulfonated polyesters (available from Eastman under the AQ series) and acrylic polymers (such as ACRONAL AC205 and ACRONAL AC 258 available from BASF) which are also reactive with free-radical systems and non-reactive acrylics (such as those available from Schenectady Chemical). Other, non-limiting examples of additional materials include the following: SBR random copolymers with low (<20%) or high (>20%) vinyl contents, available under the trade name DURADENE from Firestone (these high vinyl copolymers are reactive and contribute to the crosslinking of the system); EPDM copolymers which can react into the polymer network via unsaturated sites, and saturated analogs (e.g. EP rubber) that can modify the peel and tack of the adhesive. These are available from Exxon under the trade name VISTALON; butyl rubber, which is a copolymer of isoprene and isobutylene and is available from Exxon Chemical under the trade name VISTANEX; and liquid polyisopropylene such as is available from Kuraray, Inc. under the trade name LIR;

(g) an alcohol-containing co-reactant for cationic curing systems which is often added to adjust crosslink density, Tg, viscosity and specific adhesion. Examples include, polyester polyols available from Stepan Chemical Company and from Dow Chemical; polyalkylene oxide polyols such as PEG and PPG available from Dow Chemical; aliphatic diols such as L-2203 available from Shell (this is an ethylene butylene diol); and L-1203 an ethylene butylene mono-ol available from Shell; also useful are polybutadiene polyols available from Atochem; epoxidized polybutadiene polyols for alcohols may also be used; and

(h) other additives known to those skilled in the art. These additives may include, but are not limited to, pigments, fillers, fluorescent additives, flow and leveling additives, wetting agents, surfactants, antifoaming agents, rheology modifiers, stabilizers, and antioxidants. Preferred additives are those that do not have appreciable absorption in the wavelengths of interest.

In one embodiment, the radiation curable adhesive comprises (a) from about 5% by weight to about 60% by weight of at least one epoxidized block copolymer; (b) from about 20% by weight to about 85% by weight of at least one solid-hydrogenated tackifier; (c) about 0.02% by weight to about 5% by weight of at least one cationic photoinitiator; (d) about 0% by weight to about 40% by weight of at least one mineral oil; (e) about 0% by weight to about 40% by weight of at least one liquid tackifier; and (f) about 0% by weight to about 3% by weight of an antioxidant.

In another embodiment, the radiation curable adhesive comprises (a) from about 10% by weight to about 50% by weight of at least one epoxidized cycloaliphatic base resin; (b) about 0.1% by weight to about 2.0% by weight of at least one cationic photoinitiator; (c) about 0% by weight to about 80% by weight of at least one solid or liquid polyester diol; and (d) about 0% by weight to about 60% by weight of at least one polar tackifier. Such radiation curable adhesives are described in European Patent Application, EP 1130070.

A particularly useful radiation curable adhesive is Contour™ adhesive available from National Starch.

The adhesive is used to affix the heat shrink labels to the article or container using conventional packaging equipment. Examples of packaging equipment and label applicators are disclosed in U.S. Pat. Nos. 4,749,428; 4,844,760; 4,923,557; 5,512,120; 5,855,710; 5,858,168 and 5,964,974, incorporated by reference herein. The adhesive may be applied to a portion of the outer surface of at least one of the skin layers by any known method. For example, the adhesive may be applied by spraying, dipping, rolling, gravure or flexographic techniques.

Alternatively, the adhesive may be applied directly to the article or container to be labeled. The label is then applied to the article and subjected to heat to shrink the label onto the container so as to affix the label to container.

In one embodiment, the film is laminated to a pressure sensitive adhesive with liner. The film is die cut to form individual labels and the matrix surrounding the labels are removed. The resulting labels are then applied to a battery and shrink wrapped in a heat tunnel. The temperature of the heat tunnel is approximately 250-260° F. The labels may further include circuitry such as that used to determine the strength of the battery charge.

Table 3 contains examples of multilayered films of the present invention. These films are prepared by coextrusion and are uniaxially oriented to a stretch ratio of 5.5:1 to provide a film with a 2 mil gauge.

TABLE 3

| | Film 1 | Film 2 | Film 3 | Film 4 | Film 5 | Film 6 | Film 7 |
|---|---|---|---|---|---|---|---|
| Skin | S2 | S2 | S2 | S22 | S2 | S2 | S2 |
| layer | | | | | | | |
| Core | C1 | C2 | C3 | C4 | C5 | C7 | C8 |
| Layer | | | | | | | |
| Skin | S10 | S10 | S10 | S10 | S10 | S10 | S10 |
| Layer | | | | | | | |

The coextruded films of Table 3 had the properties listed below in Table 4.

TABLE 4

| Property | Film 1 | Film 2 | Film 3 | Film 4 | Film 5 | Film 6 | Film 7 |
|---|---|---|---|---|---|---|---|
| MD Oil^{a} | 36.6 | 39.6 | 37.3 | 25.7 | 34.1 | 41.3 | 40.6 |
| Shrink, % | | | | | | | |
| MD Oven^{b} | 43.4 | 41 | 43.3 | 33.5 | 37.3 | 50.4 | 51.6 |
| Shrink, % | | | | | | | |
| MD Shrink | 296 | 386 | 324 | 450 | 313 | 190 | 298 |
| Tension^{c}, psi | | | | | | | |
| MD Modulus^{d}, | 257,000 | 269,000 | 205,000 | 274,000 | 210,000 | 134,000 | 233,000 |
| Psi | | | | | | | |
| CD Modulus^{d}, | 135,000 | 164,000 | 117,000 | 142,000 | 129,000 | 97,000 | 104,000 |
| Psi | | | | | | | |
| MD L&W^{e}, | 21.5 | 22.5 | 22.5 | 28.9 | 23.6 | 18.6 | 17.9 |
| mN | | | | | | | |
| CD L&W^{e}, | 9.5 | 9.5 | 10.5 | 16 | 10.8 | 8.5 | 9.2 |
| mN | | | | | | | |
| Haze, % | 8.7 | 9.4 | 8.5 | 6.1 | 8.7 | 9.9 | 10.5 |

^{a}Instantaneous shrinkage 135° C. oil per ASTM Method D2732.
^{b}Ultimate shrinkage in 135° C. oven per ASTM Method D1204.
^{c}Shrink tension per ASTM Method D2838.
^{d}Tensile modulus per ASTM Method D882.
^{e}Bending resistance in millinewtons via L&W apparatus.

Table 5 provides a comparison of maximum shrink tension and force for inventive films of Samples 2 and 3 (respectively, XRFS and 1030-178-1 which correspond to Film 1 of Table 3 prepared on a pilot line coextruder and a production line coextruder) versus a commercial oriented polystyrene film (Fasson OPS), a commercial biaxially oriented polypropylene film (Mobil Roso), and an oriented polyolefin film of Sample 1 (EFD-A) containing a core layer of syndiotactice polypropylene and polypropylene copolymer.

TABLE 5

| | Shrink | | | | Shrink |
|---|---|---|---|---|---|
| Sample | Tension | L × W × T (mm) | | | Force |
| Fasson OPS 55 Spec #77018: | 545 psi | 9.973 | 5.860 | 0.050 | 1.100 |
| Sample 1: | 427 psi | 9.997 | 6.130 | 0.050 | 0.9032 |
| Sample 2 (inventive): | 386 psi | 9.996 | 5.930 | 0.050 | 0.7895 |
| Mobil Roso polypropylene: | 381 psi | 10.047 | 5.960 | 0.030 | 0.4629 |
| Sample 3 (inventive): | 335 psi | 10.040 | 5.920 | 0.060 | 0.8198 |

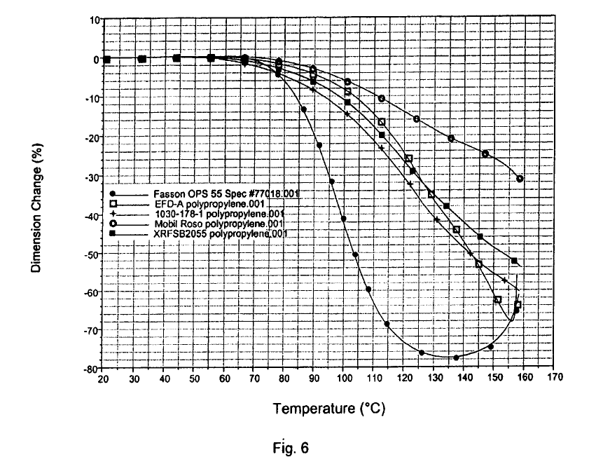

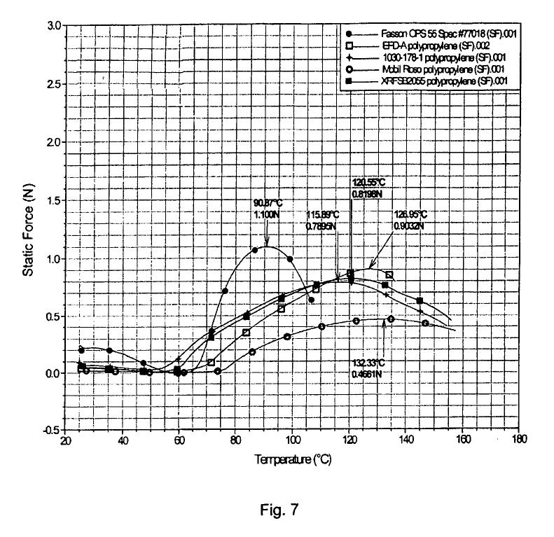

FIG. 6 depicts the % shrinkage or dimension change for the five films of Table 5 using a constant force of 0.005N versus change in temperature, from 20 to 160° Celsius.

FIG. 7 depicts the shrink force in Newtons (N) for the films of Table 5 with change in temperature, from 20 to 180° Celsius from which a maximum shrink force and tension was obtained for Table 5.

The shrink films of the present invention have high % shrinkage and equivalent or lower shrink force or tension as compared to the commercially available known films.

While the invention has been explained in relation to specific embodiments, it is to be understood that various modifications thereof will become apparent to those skilled in the art upon reading the specification. Therefore, it is to be understood that the invention disclosed herein is intended to cover such modifications as fall within the scope of the appended claims.

1. A multilayered heat shrink film for encapsulating articles comprising:
a core layer having an upper surface and a lower surface;
a first skin layer on the upper surface of the core layer; and
a second skin layer underlying the lower surface of the core layer;
wherein the core layer comprises a blend of (i) at least one polyterpene; (ii) a syndiotactic polypropylene or a cyclic olefin copolymer; and (iii) a nucleated homopolymer or copolymer of polypropylene, wherein the ultimate shrinkage of the film is at least 25% at 135° C. as measured by ASTM D1204.

2. The film of claim 1 wherein the polyterpene comprises a hydrogenated polyterpene.

3. The film of claim 1 wherein the core layer further comprises polyisobutylene.

4. The film of claim 1 wherein the core layer further comprises one or more thermoplastic polymers.

5. The film of claim 4 wherein the core layer further comprises one or more of (i) a copolymer of polypropylene and another alpha olefin, (ii) a copolymer of polyethylene and another alpha olefin, (iii) a polyethylene, and (iv) combinations thereof.

6. The film of claim 1 wherein the first and second skin layers comprise one or more polyolefins.

7. The film of claim 6 wherein the one or more polyolefins comprise one or more of a homopolymer of butylene, a copolymer of polypropylene and another alpha olefin, a copolymer of polyethylene and another alpha olefin, a polyethylene, a functionalized polyethylene, and combinations thereof.

8. The film of claim 7 wherein the first and second skin layers further comprise a hydrogenated polyterpene.

9. The film of claim 7 wherein at least one skin layer further comprises a thermoplastic material of a copolymer of an ethylene-unsaturated carboxylic acid or anhydride, an ionomer derived from sodium, lithium, or zinc and ethylene/unsaturated carboxylic acid or anhydride copolymers or combinations thereof.

10. The film of claim 1 wherein the shrink tension of the film is less than 3135 kPa at 135° C., as measured by ASTM Method D2838.

11. A heat shrink film for encapsulating articles comprising a blend of:
(i) a nucleated homopolymer of polypropylene;
(ii) at least one polyterpene; and
(iii) a syndiotactic polypropylene or a cyclic olefin copolymer wherein the ultimate shrinkage of the film is at least 25% at 135° C. as measured by ASTM Method D1204.

12. The film of claim 11 wherein the polyterpene is a hydrogenated polyterpene.

13. The film of claim 11 wherein the film further comprises one or more thermoplastic polymers.

14. The film of claim 11 wherein the film is uniaxially oriented in the machine direction only.

15. The film of claim 11 wherein the shrink tension of the film is less than 3135 kPa at 135° C. as measured by ASTM D2838.

16. The film of claim 11 wherein the film is a monolayer film.

17. The film of claim 11 wherein the film further comprises polyisobutylene.

18. The film of claim 11 wherein the film comprises a multilayer film.
